(19) United States
(12) Patent Application Publication
(10) Pub. No.: US 2026/0300777 A1
(43) Pub. Date: Oct. 1, 2026

(54) ANALYSIS SYSTEM, METHOD, AND PROGRAM

(71) Applicant: NEC Corporation, Tokyo (JP)

(72) Inventors: Shin NORIEDA, Tokyo (JP); Hisaya Wakayama, Tokyo (JP); Kenichi Takiguchi, Tokyo (JP); Chisho Ueda, Tokyo (JP); Yuto Tsukada, Tokyo (JP)

(73) Assignee: NEC Corporation, Tokyo (JP)

(21) Appl. No.: 19/577,624

(22) Filed: Mar. 25, 2026

(30) Foreign Application Priority Data
Mar. 28, 2025 (JP) 2025-054995

(51) Int. Cl. G06N 5/04

(52) U.S. Cl. CPC G06N 5/04

(57) ABSTRACT

The input unit receives an input of a question regarding a target case. The generation control unit causes a language model that has learned specialized knowledge corresponding to the case, or a language model that generates an answer using the specialized knowledge, to generate an answer to the question. The output unit outputs the generated answer in association with the specialized knowledge that serves as a basis for the answer.

### CROSS-REFERENCE TO RELATED APPLICATIONS

This application is based upon and claims the benefit of priority from the prior Japanese Patent Application No. 2025-054995, filed Mar. 28, 2025, the entire contents of which are incorporated herein by reference.

### BACKGROUND OF THE INVENTION

The present disclosure relates to an analysis system, an analysis method, and an analysis program that perform analysis with respect to a question.

When conducting new market research or business analysis, interviews may be conducted with experts who possess knowledge regarding respective businesses. In addition, a model that predicts knowledge of experts may be trained in advance, and business analysis may be performed using the model. For example, Patent Literature 1 describes a system that predicts responses from experts who have expertise in a specific field. The system described in Patent Literature 1 constructs a learning model capable of predicting answers that respective experts provide to questions by learning lifelog data of the experts.

### Prior Art Documents

### Patent Literatures

[Patent Literature 1] Japanese Patent Application Laid-Open No. 2023-114460

### SUMMARY OF THE INVENTION

On the other hand, since interviews with experts incur costs, it is assumed that experts may provide answers with a certain degree of consideration, and therefore there is a possibility that severe answers may not be obtained.

In addition, although the system described in Patent Literature 1 pseudo-outputs answers at a level desired by a user, even if a model learned from expert lifelog data is used, merely providing the obtained result poses a problem in that the result lacks persuasiveness.

Therefore, an example object of the present disclosure is to provide an analysis system, an analysis method, and an analysis program that can obtain persuasive analysis results for a question without consideration bias.

An analysis system according to the present disclosure includes: an input unit configured to receive an input of a question regarding a target case; a generation control unit configured to cause a language model that has learned specialized knowledge corresponding to the case, or a language model that generates an answer using the specialized knowledge, to generate an answer to the question; and an output unit configured to output the generated answer in association with the specialized knowledge that serves as a basis for the answer.

An analysis method according to the present disclosure includes: receiving an input of a question regarding a target case; causing a language model that has learned specialized knowledge corresponding to the case, or a language model that generates an answer using the specialized knowledge, to generate an answer to the question; and outputting the generated answer in association with the specialized knowledge that serves as a basis for the answer.

An analysis program according to the present disclosure causes a computer to execute: an input process of receiving an input of a question regarding a target case; a generation control process of causing a language model that has learned specialized knowledge corresponding to the case, or a language model that generates an answer using the specialized knowledge, to generate an answer to the question; and an output process of outputting the generated answer in association with the specialized knowledge that serves as a basis for the answer.

According to the present disclosure, persuasive analysis results can be obtained for a question without consideration bias.

### BRIEF DESCRIPTION OF DRAWINGS

FIG. 1 is an explanatory diagram illustrating a configuration example of an example embodiment of the analysis system according to the present disclosure.

FIG. 2 is a flowchart illustrating an operation example of the analysis system.

FIG. 3 is a block diagram illustrating an overview of the analysis system according to the present disclosure.

FIG. 4 is a schematic block diagram illustrating a configuration of a computer according to at least one example embodiment.

### DETAILED DESCRIPTION OF THE INVENTION

Hereinafter, example embodiments of the present disclosure will be described with reference to the drawings.

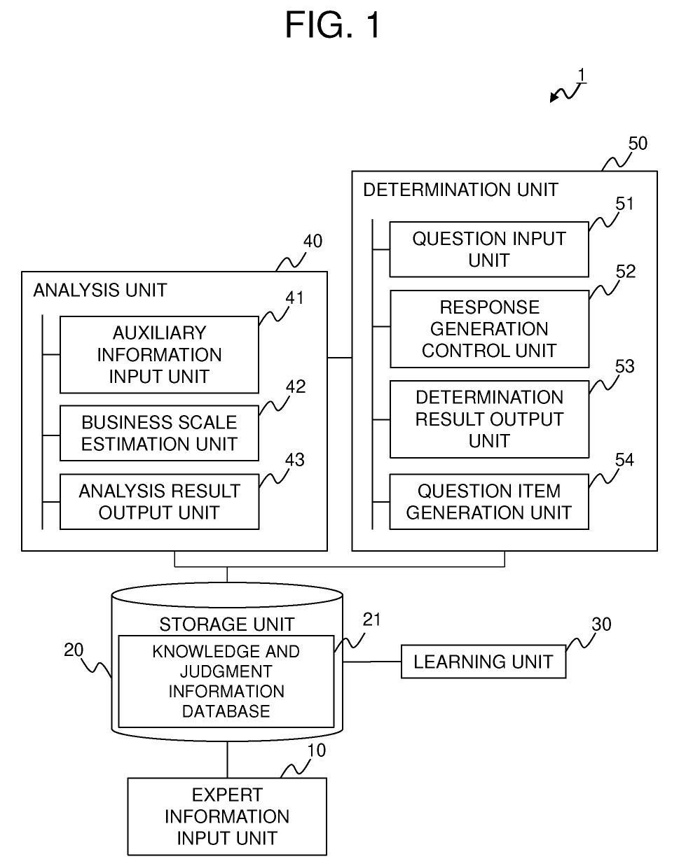

FIG. 1 is an explanatory diagram illustrating a configuration example of an analysis system according to an example embodiment of the present disclosure. An analysis system 1 according to the present example embodiment includes an expert information input unit 10, a storage unit 20, a learning unit 30, an analysis unit 40, and a determination unit 50.

In the present example embodiment, it is assumed that a base model of a language model that has completed pre-training is stored in the storage unit 20 as an initial state. The language model is used as necessary when understanding sentence structures and contexts. The form of the language model is not particularly limited, and for example, may be implemented by a neural network.

The expert information input unit 10 receives input of specialized knowledge corresponding to a case, which may also be referred to as expert information, for example, specialized knowledge that is determined based on knowledge of experts. The content and field of the specialized knowledge are not particularly limited as long as the knowledge relates to business associated with the case. Although the specialized knowledge does not necessarily need to be highly advanced knowledge, receiving input of advanced knowledge unique to experts is preferable because expertise of the language model described later can thereby be improved.

The representation form of the specialized knowledge is arbitrary. The expert information input unit 10 may receive input of specialized knowledge described in a predetermined format for each business, or may receive input of specialized knowledge expressed in a conversational format such as an interview with an expert.

The storage unit 20 stores various types of information used for processing by the analysis system 1. In the present example embodiment, the storage unit 20 may store specialized knowledge received by the expert information input unit 10. The storage unit 20 may also store the language model described above.

The storage unit 20 includes a knowledge and judgment information database 21. The knowledge and judgment information database 21 stores specialized knowledge that is determined based on expert knowledge and classified for each business. The specialized knowledge stored in the knowledge and judgment information database 21 may include specialized knowledge received by the expert information input unit 10, and may also include specialized knowledge obtained by the learning unit 30 described later. The storage unit 20 may be implemented by a magnetic disk or the like.

The learning unit 30 learns the language model using the input specialized knowledge. Specifically, the learning unit 30 generates a language model that generates answers using specialized knowledge in a business. The language model assumed in the present example embodiment is arbitrary as long as it can obtain answers that consider specialized knowledge. For example, the language model may be a model that has learned specialized knowledge corresponding to a business, or may be a model that generates answers using specialized knowledge in a business.

Further, the learning unit 30 may generate a language model that has learned specialized knowledge corresponding to a business scale, or may learn a language model that generates answers using the specialized knowledge. A method for estimating the business scale will be described later.

The learning unit 30 may perform post-training of the language model by adjusting parameters through fine-tuning using the specialized knowledge. Since a method of performing fine-tuning using an added dataset is widely known, detailed description is omitted.

Further, the learning unit 30 may classify the specialized knowledge received by the expert information input unit 10 for each business and register the classified specialized knowledge in the knowledge and judgment information database 21. For example, the learning unit 30 may cause the language model to interpret text input to the expert information input unit 10, classify the text for each business, and register the classified specialized knowledge for each business in the knowledge and judgment information database 21. However, the method for classifying specialized knowledge for each business is not limited thereto.

The analysis unit 40 includes an auxiliary information input unit 41, a business scale estimation unit 42, and an analysis result output unit 43.

The auxiliary information input unit 41 receives input of tasks in a business that are divided into appropriate sizes, which are hereinafter referred to as divided tasks. An appropriate size refers to a size of a task that is not influenced by personal characteristics and that can be identified as a single action. For example, in a business of stocking goods in a store, the business may be divided into tasks such as inventory confirmation, unpacking, repackaging, cleaning up, information association, transportation, and display.

In the present example embodiment, the auxiliary information input unit 41 receives input of tasks of a business that are divided by an expert or the like. However, the divided tasks of the business may be stored in advance in the storage unit 20. In that case, the auxiliary information input unit 41 may acquire information of the divided tasks from the storage unit 20.

The business scale estimation unit 42 estimates a business scale of a business. In the present example embodiment, a method by which the business scale estimation unit 42 estimates a business scale of a case relating to business development will be described. By using the estimated business scale as a dataset of the language model, the language model can generate answers that consider the business scale in response to interviews from a user.

As one method for estimating the business scale, a method using Fermi estimation may be adopted. The knowledge and judgment information database 21 stores specialized knowledge for each business. The business scale estimation unit 42 may calculate, by Fermi estimation, estimated values representing a business scale such as TAM (Total Addressable Market ), SAM (Serviceable Available Market), and SOM (Serviceable Obtainable Marlet) from a target domain and specialized knowledge that indicates specific grounds in the domain. Since a method of performing Fermi estimation is widely known, detailed description is omitted.

The method for extracting data that indicates specific grounds from the specialized knowledge stored in the knowledge and judgment information database 21 is arbitrary. For example, the knowledge and judgment information database 21 may store the specialized knowledge in a form that allows data indicating such specific grounds to be identified.

As another method for estimating the business scale, a method of estimating the business scale by collecting Web information relating to the business may be adopted. For example, Web information relating to the business that is collected by an administrator or the like may be registered in the knowledge and judgment information database 21, and the business scale estimation unit 42 may estimate the business scale based on the registered information.

When causing the language model to generate answers in consideration of the business scale, the learning unit 30 may generate a language model that has learned specialized knowledge corresponding to the business scale estimated by the business scale estimation unit 42, or may learn a language model that generates answers using the specialized knowledge.

The analysis result output unit 43 outputs information relating to a target domain from the knowledge and judgment information database 21. The knowledge and judgment information database 21 stores information relating to a plurality of business target domains, for example, respective operations in manufacturing, retail, and construction industries. The analysis result output unit 43 outputs information relating to a desired business target domain.

For example, when a specific business target domain is not designated, the analysis result output unit 43 may output information for each target domain. When a specific business target domain is input to the question input unit 51 described later, the analysis result output unit 43 may output information of the designated target domain.

The determination unit 50 includes a question input unit 51, a response generation control unit 52, a determination result output unit 53, and a question item generation unit 54.

The question input unit 51 receives input of a question from a user regarding a target case. The case is not limited to a specific business and refers to questions relating to business in general. An example of the case includes determining a business target domain. The question may include information relating to a specific business or may not include such information.

The response generation control unit 52 causes the language model to generate an answer to the received question. At that time, the response generation control unit 52 may cause the language model to generate the answer using information output by the analysis result output unit 43. In general, a question input to the question input unit 51 defines whose problem it is. When such a definition is not provided, the response generation control unit 52 may cause the language model to output an answer based on a hypothesis regarding whose problem it is. By outputting such an answer, it becomes possible to collect evidence relating to the problem.

The determination result output unit 53 outputs the generated answer as an analysis result. The determination result output unit 53 outputs the generated answer in association with the specialized knowledge that serves as a basis for the answer.

Specifically, the determination result output unit 53 may extract, from the specialized knowledge registered in the knowledge and judgment information database 21, specialized knowledge that was used when generating the answer, and output the extracted specialized knowledge as grounds in association with the answer. By outputting the answer by the determination result output unit 53 in association with the specialized knowledge that serves as grounds, it becomes possible to present persuasive analysis results to a user.

The question item generation unit 54 receives input of a user's hypothesis regarding an issue and creates question items representing what should be asked and to whom in order to confirm the input hypothesis. The response generation control unit 52 may cause the language model to generate answers to the created question items.

The hypothesis regarding the issue refers to a hypothesis assumed for solving a current issue. The question item generation unit 54 may extract, from an input question, a sentence indicating a current issue and a user's assumption regarding the issue, combine the extracted information, and generate a sentence to be asked as a question item.

The question item generation unit 54 may also create candidates of hypotheses different from the input hypothesis and additional question items for confirming the candidate hypotheses. For example, the question item generation unit 54 may extract a sentence indicating a current issue from the input question and cause the language model to output candidates for solving the issue. The question item generation unit 54 may then cause the language model to generate question items that combine the sentence indicating the current issue and the candidates for solving the issue.

The expert information input unit 10, the learning unit 30, the analysis unit 40, specifically the auxiliary information input unit 41, the business scale estimation unit 42, and the analysis result output unit 43, and the determination unit 50, specifically the question input unit 51, the response generation control unit 52, the determination result output unit 53, and the question item generation unit 54, are implemented by a processor of a computer that operates according to a program (analysis program), for example, a CPU (Central Processing Unit).

For example, the program is stored in the storage unit 20 of the analysis system 1, and the processor reads the program and operates as the expert information input unit 10, the learning unit 30, the analysis unit 40, specifically the auxiliary information input unit 41, the business scale estimation unit 42, and the analysis result output unit 43, and the determination unit 50, specifically the question input unit 51, the response generation control unit 52, the determination result output unit 53, and the question item generation unit 54, in accordance with the program.

The respective functions of the analysis system 1 may be provided in a SaaS (Software as a Service) format. The expert information input unit 10, the learning unit 30, the analysis unit 40, specifically the auxiliary information input unit 41, the business scale estimation unit 42, and the analysis result output unit 43, and the determination unit 50, specifically the question input unit 51, the response generation control unit 52, the determination result output unit 53, and the question item generation unit 54 may each be implemented by dedicated hardware.

Some or all of the respective components of each device may be implemented by general-purpose or dedicated circuitry, a processor, or a combination thereof. These may be configured by a single chip or may be configured by a plurality of chips connected via a bus. Some or all of the respective components of each device may be implemented by a combination of the circuitry described above and a program.

When some or all of the respective components of the analysis system 1 are implemented by a plurality of information processing apparatuses or circuitry, the plurality of information processing apparatuses or circuitry may be arranged in a centralized manner or in a distributed manner. For example, the information processing apparatuses or circuitry may be implemented in a form in which they are connected via a communication network, such as a client-server system or a cloud computing system.

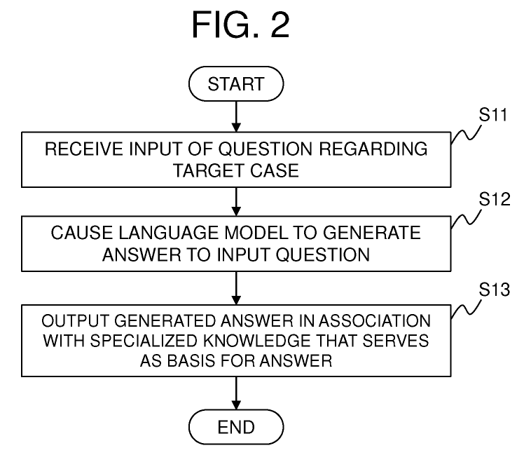

Next, an operation example of the analysis system 1 according to the present example embodiment will be described. FIG. 2 is a flowchart illustrating an operation example of the analysis system 1.

The question input unit 51 receives input of a question regarding a target case (Step S11). The response generation control unit 52 causes the language model to generate an answer to the input question (Step S12). The determination result output unit 53 outputs the generated answer in association with the specialized knowledge that serves as a basis for the answer (Step S13).

As described above, according to the present example embodiment, the question input unit 51 receives input of a question regarding a target case, the response generation control unit 52 causes the language model to generate an answer to the input question, and the determination result output unit 53 outputs the generated answer in association with the specialized knowledge that serves as a basis for the answer. Therefore, persuasive analysis results can be obtained without consideration bias.

For example, consider a case in which a business developer conducts interviews with experts in order to determine a business target domain. Since the business developer pays for the interviews to reduce man-hours, there is a possibility that experts may provide answers with consideration, that is, answers that avoid negative reactions, and it may be difficult to extract accurate answers.

In contrast, in the present example embodiment, since a language model that has learned specialized knowledge is used, the response generation control unit 52 causes the language model to generate answers to interviews received from a user by the question input unit 51. Therefore, severe answers that do not easily respond affirmatively can be obtained, and differentiation from ordinary interview matching services can be achieved.

In another case in which a business developer conducts interviews with experts in order to determine a business target domain, if the interviewer repeatedly asks questions without getting to the point in an attempt to obtain a solution, experts may become exhausted and may give up providing accurate information.

In this regard as well, in the present example embodiment, since a language model that has learned specialized knowledge is used and the response generation control unit 52 causes the language model to generate answers to interviews received from a user by the question input unit 51, it is possible to suppress degradation in answer quality due to exhaustion that may occur in human interviews.

Further, in the present example embodiment, the question item generation unit 54 creates question items for confirming a hypothesis regarding an issue. In addition, the question item generation unit 54 creates candidates of answers different from the hypothesis and additional questions for such candidates. Therefore, it is possible to avoid a situation in which an interviewer repeatedly asks unfocused questions.

Further, consider a case in which a business developer determines a business target domain. In the present example embodiment, the knowledge and judgment information database 21 stores, as specialized information, information obtained by analyzing knowledge and judgments acquired from experts in a manner organized for each business. The business scale estimation unit 42 performs Fermi estimation in order to estimate a scale of a target business, thereby making it possible to calculate estimated values such as TAM, SAM, and SOM.

Further, consider a case in which a result obtained by the language model is output as expert information instead of an answer by an expert. Since the result obtained by the language model is not primary information, that is, not a raw voice, it may be difficult to obtain understanding from investors such as shareholders. In contrast, in the present example embodiment, the determination result output unit 53 outputs information in association with original information obtained from experts. Therefore, it becomes possible to improve understanding of investors.

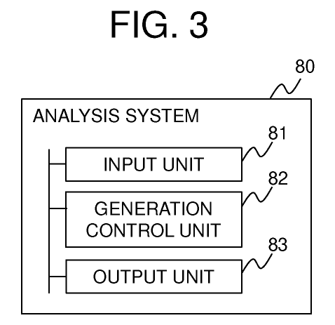

Next, an overview of the present disclosure will be described. FIG. 3 is a block diagram illustrating an overview of an analysis system according to the present disclosure. An analysis system 80 (for example, the analysis system 1) includes an input unit 81 (for example, the question input unit 51) that receives input of a question regarding a target case, a generation control unit 82 (for example, the response generation control unit 52) that causes a language model that has learned specialized knowledge corresponding to the case, or a language model that generates an answer using the specialized knowledge, to generate an answer to the question, and an output unit 83 (for example, the determination result output unit 53) that outputs the generated answer in association with the specialized knowledge that serves as a basis for the answer.

With such a configuration, persuasive analysis results can be obtained without consideration bias.

The analysis system 80 may further include an estimation unit (for example, the business scale estimation unit 42) that estimates a business scale of a case relating to business development. The generation control unit 82 may cause a language model that has learned specialized knowledge corresponding to the estimated business scale, or a language model that generates an answer using the specialized knowledge, to generate an answer to the question.

Specifically, the estimation unit may calculate, by Fermi estimation, an estimated value representing a business scale from a target domain and specialized knowledge that indicates specific grounds in the domain.

The analysis system 80 may further include a question creation unit (for example, the question item generation unit 54) that receives input of a user's hypothesis regarding an issue and creates a question item for confirming the input hypothesis. The input unit 81 may receive input of the created question items.

The analysis system 80 may further include a learning unit (for example, the learning unit 30) that learns the language model using specialized knowledge in a business. The learning unit may perform post-training of the language model by adjusting parameters through fine-tuning using the specialized knowledge.

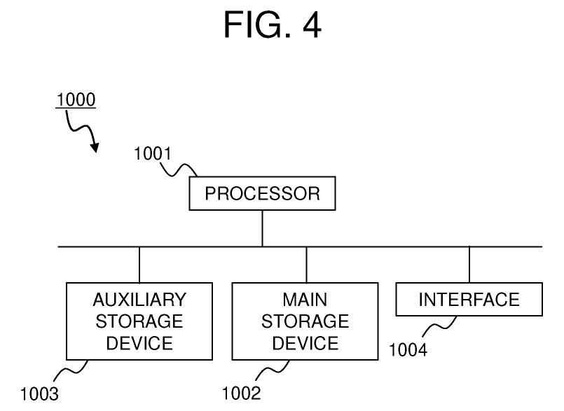

FIG. 4 is a schematic block diagram illustrating a configuration of a computer according to at least one example embodiment. A computer 1000 includes a processor 1001, a main storage device 1002, an auxiliary storage device 1003, and an interface 1004. A computer that executes a mathematical programming solver, an annealing machine, a simulator, or the like may be connected to the computer 1000.

The analysis system 80 described above is implemented in the computer 1000. Operations of the respective processing units described above are stored in the auxiliary storage device 1003 in the form of a program, that is, an analysis program. The processor 1001 reads the program from the auxiliary storage device 1003 into the main storage device 1002 and executes the processing according to the program.

In at least one example embodiment, the auxiliary storage device 1003 is an example of a non-transitory tangible medium. Other examples of the non-transitory tangible medium include a magnetic disk, a magneto-optical disk, a CD-ROM (Compact Disc Read-only Memory), a DVD-ROM (Read-only Memory), and a semiconductor memory that are connected via the interface 1004. When the program is distributed to the computer 1000 via a communication line, the computer 1000 that receives the distribution may expand the program into the main storage device 1002 and execute the processing described above.

The program may implement part of the functions described above. Further, the program may be a so-called differential file, that is, a differential program, that implements the functions described above in combination with another program that is already stored in the auxiliary storage device 1003.

Although the invention of the present application has been described above with reference to example embodiments and examples, the invention is not limited to the above example embodiments and examples. Various modifications that can be understood by those skilled in the art may be made within the scope of the invention.

1. An analysis system comprising:
a memory storing instructions; and
one or more processors configured to execute the instructions to:
receive an input of a question regarding a target case;
cause a language model that has learned specialized knowledge corresponding to the case, or a language model that generates an answer using the specialized knowledge, to generate an answer to the question; and
output the generated answer in association with the specialized knowledge that serves as a basis for the answer.

2. The analysis system according to claim 1, wherein the processor is configured to execute the instructions to:
estimate a business scale of the case regarding business development; and
cause a language model that has learned specialized knowledge corresponding to the estimated business scale, or a language model that generates an answer using the specialized knowledge, to generate an answer to the question.

3. The analysis system according to claim 2, wherein the processor is configured to execute the instructions to calculate, by Fermi estimation, an estimated value representing the business scale from a target domain and specialized knowledge that indicates specific grounds in the domain.

4. The analysis system according to claim 1, wherein the processor is configured to execute the instructions to:
receive an input of a user's hypothesis regarding an issue and to create a question item for confirming the input hypothesis; and
receive an input of the created question item.

5. The analysis system according to claim 1, wherein the processor is configured to execute the instructions to:
learn the language model using specialized knowledge in a business; and
perform post-training of the language model by adjusting parameters through fine-tuning using the specialized knowledge.

6. An analysis method comprising:
receiving an input of a question regarding a target case;
causing a language model that has learned specialized knowledge corresponding to the case, or a language model that generates an answer using the specialized knowledge, to generate an answer to the question; and
outputting the generated answer in association with the specialized knowledge that serves as a basis for the answer.

7. The analysis method according to claim 6, further comprising:
estimating a business scale of the case regarding business development; and
causing a language model that has learned specialized knowledge corresponding to the estimated business scale, or a language model that generates an answer using the specialized knowledge, to generate an answer to the question.

8. A non-transitory computer readable information recording medium storing an analysis program, when executed by a processor, that performs a method for:
receiving an input of a question regarding a target case;
causing a language model that has learned specialized knowledge corresponding to the case, or a language model that generates an answer using the specialized knowledge, to generate an answer to the question; and
outputting the generated answer in association with the specialized knowledge that serves as a basis for the answer.

9. The non-transitory computer readable information recording medium according to claim 8, wherein the dialogue program performs a method for:
estimating a business scale of the case regarding business development; and
causing a language model that has learned specialized knowledge corresponding to the estimated business scale, or a language model that generates an answer using the specialized knowledge, to generate an answer to the question.
